(19) United States
(12) Patent Application Publication
(10) Pub. No.: US 2025/0246185 A1
(43) Pub. Date: Jul. 31, 2025

(54) METHOD AND APPARATUS FOR CLASSIFYING GENERATED SPEECH

(71) Applicant: FOUNDATION OF SOONGSIL UNIVERSITY-INDUSTRY COOPERATION, Seoul (KR)

(72) Inventors: Dae Seon CHOI, Daejeon (KR); Seung Min KIM, Gimpo-si, Gyeonggi-do (KR)

(21) Appl. No.: 19/184,526

(22) Filed: Apr. 21, 2025

Related U.S. Application Data
(63) Continuation of application No. PCT/KR2023/020518, filed on Dec. 13, 2023.

(30) Foreign Application Priority Data
Nov. 6, 2023 (KR) 10-2023-0151614

(51) Int. Cl. G10L 15/16; G10L 15/02; G10L 19/038

(52) U.S. Cl. CPC G10L 15/16; G10L 15/02; G10L 19/038

(57) ABSTRACT

A method and apparatus for classifying generated speech are disclosed. The method for classifying generated speech includes: applying a one-dimensional convolution operation to raw speech data to embed the raw speech data into a feature space and extract a feature vector; quantizing the feature vector by applying it to a residual vector quantizer; and applying the quantized result to a classifier model including a natural language processing model to output a classification label.

### CROSS-REFERENCE TO RELATED APPLICATION

This application is a bypass continuation of pending PCT International Application No. PCT/KR2023/020518, which was filed on Dec. 13, 2023, and which claims priority to Korean Patent Application No. 10-2023-0151614, which was filed in the Korean Intellectual Property Office on Nov. 6, 2023. The disclosures of which are hereby incorporated by reference in their entireties.

### STATEMENT REGARDING PRIOR DISCLOSURES BY THE INVENTOR OR A JOINT INVENTOR

At least one inventor or joint inventor of the present disclosure has made related disclosures in a research paper (Speech Synthesis Classification Using Bert, Conference on Information Security and Cryptography (CISC)) on Sep. 9, 2023, which was included in the information disclosure statement submitted with this application.

### TECHNICAL FIELD

The present disclosure relates to a method and an apparatus for generated speech classification.

### BACKGROUND ART

Recent speech generation technologies have been rapidly advancing, with Text-to-Speech (TTS) and Voice Conversion (VC) being representative examples. In practice, models such as TTS and VC have already been successfully commercialized, making them easily accessible to the general public. These commercialized speech generation technologies, including TTS and VC, are capable of producing highly natural synthesized speech, and have advanced to the point of generating speech that is nearly indistinguishable from that of a human. However, the advancement of such speech generation technologies has also led to an increase in misuse cases, such as voice phishing.

### DISCLOSURE

### Technical Problem

An object of the present disclosure is to provide a method and an apparatus for classifying generated speech.

Another object of the present disclosure is to provide a method and an apparatus for classifying generated speech that can accurately determine the authenticity of generated speech.

Still another object of the present disclosure is to provide a method and an apparatus for classifying generated speech, which can determine the authenticity of speech in audio form by considering overall context through a text-based language model.

### Technical Solution

According to one aspect of the present disclosure, a method for classifying generated speech is provided.

According to an embodiment of the present disclosure, a method for classifying generated speech may be provided, the method comprising: applying a one-dimensional convolution operation to raw speech data to embed the data into a feature space and extract a feature vector; quantizing the feature vector by applying it to a residual vector quantizer; and applying the quantized result to a classifier model including a natural language processing model to output a classification label.

The natural language processing model comprises a BERT (Bidirectional Encoder Representations from Transformers) language model, and the classifier model is configured to output a classification label indicating one of generated speech and real speech based on an output of the BERT language model.

The quantized result is represented as a vector reflecting overall contextual structure through the BERT language model, and the vector is passed through a fully connection layer and a softmax activation function of the classifier model to output a classification label indicating one of generated speech and real speech.

The residual vector quantizer is configured to quantize the feature vector, which is a one-dimension array of real values, into positive integer values.

The residual vector quantizer is configured to quantize the feature vector differently according to a length of the raw speech data.

According to another aspect of the present disclosure, an apparatus for classifying generated speech is provided.

According to an embodiment of the present disclosure, an apparatus for classifying generated speech may include: a feature extractor configured to apply a one-dimensional convolution operation to raw speech data to embed the data into a feature space and extract a feature vector; a quantizer disposed downstream of the feature extractor and configured to quantize the feature vector; and a classifier model configured to receive an output of the quantizer and output a speech classification result with contextual awareness.

The quantizer may be a residual vector quantizer, and may be configured to quantize the feature vector, which is a one-dimensional array of real values, into positive integer values.

The residual vector quantizer is configured to quantize the feature vector differently according to a length of the raw speech data.

The classifier model may include, at its front end, a BERT (Bidirectional Encoder Representations from Transformers) language model as a natural language processing model, and may include a fully connected layer and a softmax activation layer at a rear end of the BERT language model. An output of the quantizer may be represented as a vector reflecting the overall contextual structure through the BERT language model, and may be passed through the fully connected layer and the softmax activation function of the classifier model to output a classification label of either generated speech or real speech.

### Advantageous Effects

According to an embodiment of the present disclosure it is possible to accurately determine the authenticity of generated speech by providing a method and an apparatus for classifying generated speech.

In addition, the present disclosure enables the determination of the authenticity of speech by processing audio-form speech with a natural language processing-based language model that considers the overall context.

### BRIEF DESCRIPTION OF THE DRAWINGS

FIG. 1 is a flowchart illustrating a method for classifying generated speech according to an embodiment of the present disclosure.

FIG. 2 is a diagram illustrating the detailed structure of a quantizer according to an embodiment of the present disclosure.

FIG. 3 is a diagram illustrating pseudocode for a residual vector quantization method according to an embodiment of the present disclosure.

FIG. 4 is a diagram illustrating the structure of a BERT language model according to an embodiment of the present disclosure.

FIGS. 5 to 7 are diagrams illustrating classification results of a generated speech classification apparatus according to an embodiment of the present disclosure.

FIG. 8 is a block diagram schematically illustrating the internal configuration of a generated speech classification apparatus according to an embodiment of the present disclosure.

FIG. 9 is a diagram illustrating the detailed structure of an encoder according to an embodiment of the present disclosure.

### BEST MODE

In the present specification, singular forms include plural forms unless the context clearly indicates otherwise. In the specification, the terms “composed of” or “include,” and the like, should not be construed as necessarily including all of several components or several steps described in the specification, and it should be construed that some component or some steps among them may not be included or additional components or steps may be further included. In addition, the terms “. . . unit”, “module”, and the like disclosed in the specification refer to a processing unit of at least one function or operation and this may be implemented by hardware or software or a combination of hardware and software.

Hereinafter, the embodiments of the present disclosure will be described in detail with reference to the accompanying drawings.

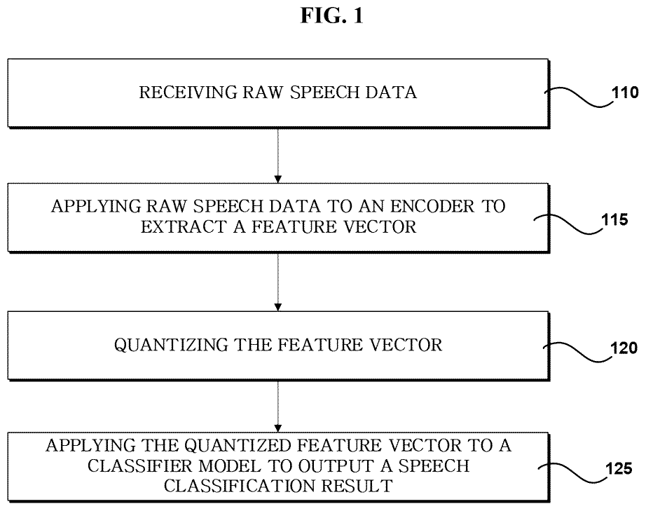

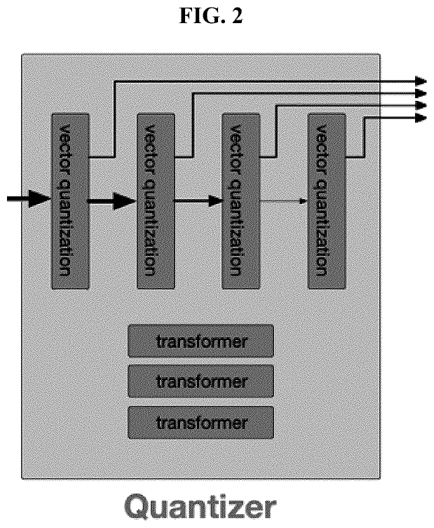

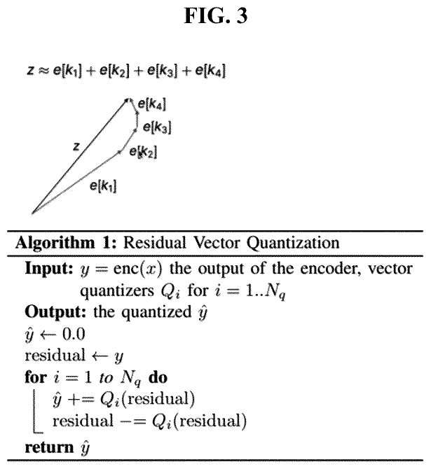

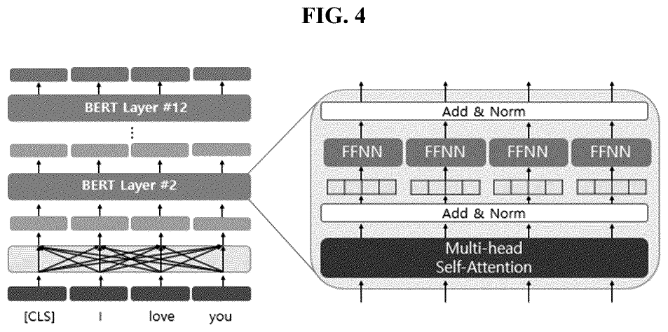

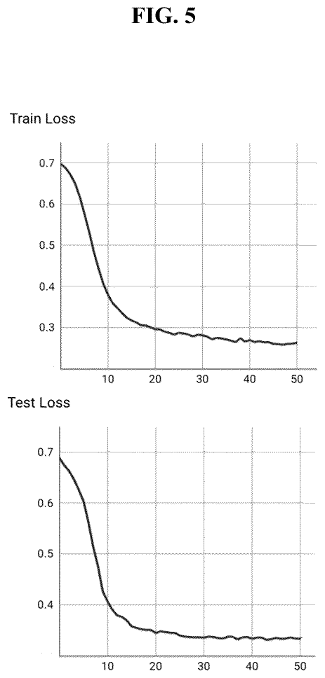

FIG. 1 is a flowchart illustrating a method for classifying generated speech according to an embodiment of the present disclosure, FIG. 2 is a diagram illustrating the detailed structure of a quantizer according to an embodiment of the present disclosure, FIG. 3 is a diagram illustrating pseudocode for a residual vector quantization method according to an embodiment of the present disclosure, FIG. 4 is a diagram illustrating the structure of a BERT language model according to an embodiment of the present disclosure, FIGS. 5 to 7 are diagrams illustrating classification results of a generated speech classification apparatus according to an embodiment of the present disclosure.

In step 110, the generated speech classification apparatus 100 receives raw speech data as input.

Here, the raw speech data refers to unprocessed (raw) data, and the length of the speech data may vary depending on the sampling rate and bit rate.

In step 115, the generated speech classification apparatus 100 applies the raw speech data to an encoder to extract a feature vector.

In an embodiment of the present disclosure, it is assumed that the generated speech classification apparatus 100 extracts a feature vector from the raw speech data by performing a one-dimensional convolution operation using an encoder of an Encodec model, and the following description will be provided based on this assumption. However, the present disclosure is not limited to the Encodec model, and any network capable of applying a one-dimensional convolution operation may be used without limitation.

In step 120, the generated speech classification apparatus 100 applies the extracted feature vector to a quantizer to perform quantization. In this case, the quantizer may be a residual vector quantizer. The generated speech classification apparatus 100 may convert the extracted feature vector, which is in the form of real values, into positive integer values using the residual vector quantizer.

The detailed structure of the quantizer is illustrated in FIG. 2.

As shown in FIG. 2, the quantizer may include four vector quantization (VQ) modules and three transformers.

The quantizer passes the non-quantized feature vector through a first vector quantization (VQ) module, calculates a quantization residual, and then repeatedly quantizes the quantization residual using a series of additional N_{q}−1 VQ modules.

The total number of bits may be uniformly allocated to each VQ module. This is, rᵢ=r/N_{q}=log₂N Pseudocode for the residual vector quantization method is illustrated in FIG. 3.

The generated speech classification apparatus 100 according to an embodiment of the present disclosure may receive speech in the form of raw audio, embed the speech into a feature space through a backbone network so that it can be applied to a BERT language model, which is a natural language processing-based language model, extract a feature vector in the form of a one-dimensional array of real values, and quantize the feature vector into positive integer values. In this manner, by quantizing the feature vector—which includes both speech features and sequential information—into positive integer values using a residual vector quantizer, the speech can be converted into a format suitable for input to the BERT language model.

In step 125, the generated speech classification apparatus 100 applies the quantized result to a classifier model to output a speech classification result. Here, the classifier model may include a BERT language model at a front end of the classifier.

Accordingly, the quantized result is input to the BERT language model, which is a natural language processing model, the BERT language model may learn bidirectional contextual information and inter-sentence relationships, including sequential order of sentence, based on the quantized result, and represent each word as a vector that reflects its context. The detailed structure of the BERT language model is illustrated in FIG. 4.

The output of the BERT language model may be passed through a fully connected layer and a softmax activation function, which are positioned at a rear end of the BERT language model, to assign a classification label. In an embodiment of the present disclosure, the classification label may indicate one of generated speech and real speech.

As described above, the quantized result was applied to the classifier model, and the BERT language model was fine-tuned to effectively operate on speech data. The results of the experiment are shown in FIGS. 5 through 7.

FIG. 5 shows the results of evaluating two types of loss. The training loss decreased to 0.2628, and the test loss also decreased to 0.3331. This indicates that the model exhibits high performance on the training data while also being capable of making generalized predictions on new data.

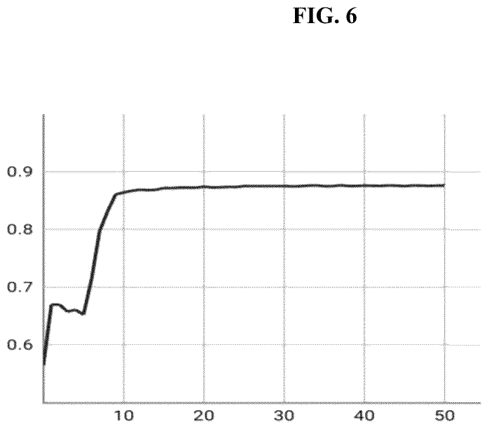

As a result of evaluating the accuracy of the model, an accuracy of 0.875 was achieved when the dataset was configured with a 1:1 ratio of generated speech to real speech (see FIG. 6). This indicates that the model demonstrates excellent performance even in situations where the proportions of generated and real speech are equal.

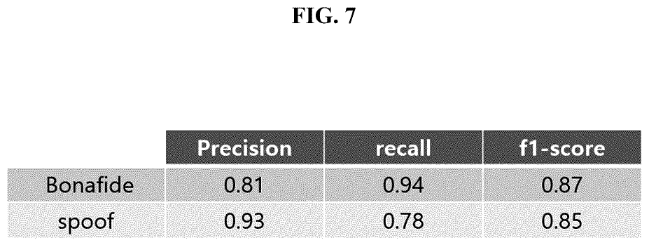

Conventional techniques showed high accuracy when the ratio of generated speech to real speech was imbalanced, but performed poorly in other evaluation metrics such as precision, F1 score, and recall. However, as shown in FIG. 7, the generated speech classification model according to an embodiment of the present disclosure demonstrates strong performance in precision, F1 score, and recall as well.

As described above, the generated speech classification apparatus 100 not only preserves a large amount of information by using raw speech data, but also embeds the speech into a feature space, extracts a feature vector in the form of real values, quantizes the feature vector into positive integer values through residual vector quantization, analyzes sequential information using a natural language processing model, namely a BERT language model, and classifies the input into one of generated speech and real speech by passing the result through a fully connected layer and a softmax activation function of the classifier model.

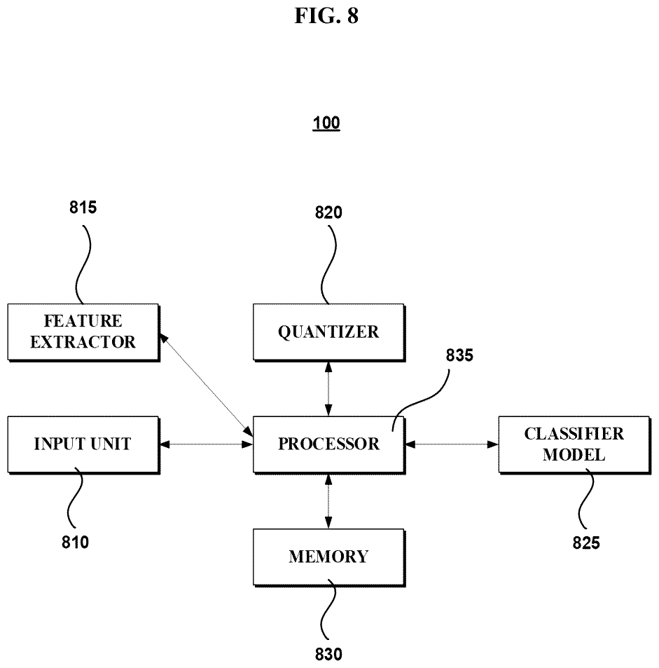

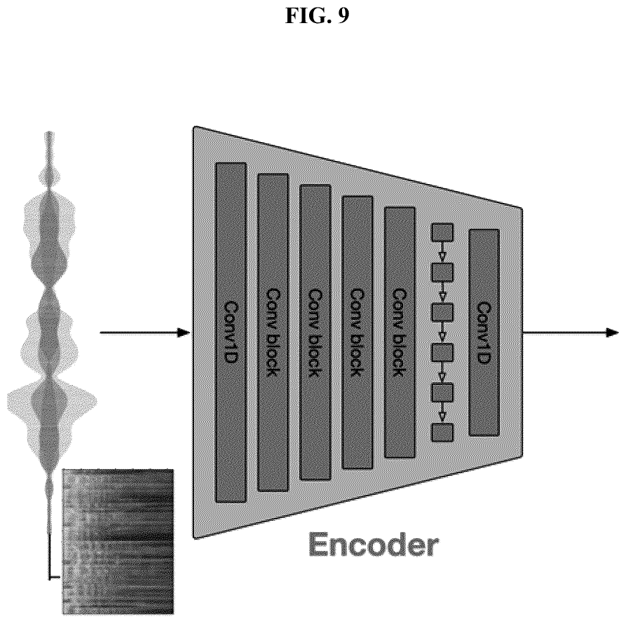

FIG. 8 is a block diagram schematically illustrating the internal configuration of a generated speech classification apparatus according to an embodiment of the present disclosure, and FIG. 9 is a diagram illustrating the detailed structure of an encoder according to an embodiment of the present disclosure.

Referring to FIG. 8, a generated speech classification apparatus 100 according to an embodiment of the present disclosure includes an input unit 810, a feature extraction unit 815, a quantization unit 820, a classifier model 825, a memory 830, and a processor 835.

The input unit 810 is a means for receiving raw speech data. Here, the raw speech data refers to unprocessed data, and the bit rate (or sample rate) may vary. That is, the length of the raw speech data may differ.

The feature extraction unit 815 may apply the raw speech data to an encoder, embed it into a feature space, and extract a feature vector in the form of a one-dimensional array of real values. The detailed structure of the encoder is illustrated in FIG. 9.

The quantization unit 820 is disposed downstream of the feature extraction unit 815 and serves as a means for quantizing the feature vector output from the feature extraction unit 815. As described above, the quantization unit 820 may be a residual vector quantizer. The quantization unit 820 may convert the feature vector, which consists of real values, into positive integer values.

Through this process, the speech data can be made suitable for processing by a natural language processing language model, namely a BERT language model.

The classifier model 825 may receive an output of the quantization unit 820 and output a speech classification result with contextual awareness through a BERT language model.

As described above, the classifier model 825 includes a BERT language model at its front end. Accordingly, the output of the quantization unit 820 may be applied to the BERT language model and represented as a vector reflecting the overall contextual structure. The classifier model 825 may classify the vector output from the BERT language model into a classification label of either generated speech or real speech by applying a fully connected layer and a softmax activation function.

As described above, by including a natural language processing model, namely a BERT language model, in the classifier model, a feature vector encoded from audio-form speech can be quantized into positive integer values and applied to the BERT language model for processing. Through this, speech classification can be performed by considering sequential information that reflects the overall contextual structure of the speech in audio form.

The memory 830 stores instructions for performing the generated speech classification method according to an embodiment of the present disclosure.

The processor 835 is a means for controlling internal components of the generated speech classification apparatus 100 according to an embodiment of the present disclosure, such as the input unit 810, the feature extraction unit 815, the quantization unit 820, the classifier model 825, and the memory 830.

The apparatus and the method according to the embodiment of the present disclosure may be implemented in a form of program commands that may be executed through various computer means and may be recorded in a computer-readable recording medium. The computer-readable recording medium may include a program command, a data file, a data structure, or the like, alone or in a combination thereof. The program commands recorded in the computer-readable recording medium may be especially designed and constituted for the present disclosure or be known to and usable by those skilled in a field of computer software. Examples of the computer-readable recording medium may include magnetic media such as a hard disk, a floppy disk, and a magnetic tape; optical media such as a compact disk read only memory (CD-ROM) or a digital versatile disk (DVD); magneto-optical media such as a floptical disk; and a hardware device specially configured to store and execute program commands, such as a ROM, a random access memory (RAM), a flash memory, or the like. Examples of the program commands include a high-level language code capable of being executed by a computer using an interpreter, or the like, as well as a machine language code made by a compiler.

The above-mentioned hardware device may be constituted to be operated as one or more software modules in order to perform an operation according to the present disclosure, and vice versa.

Hereinabove, the present disclosure has been described with reference to exemplary embodiments thereof. It will be understood by those skilled in the art to which the present disclosure pertains that the present disclosure may be implemented in a modified form without departing from essential features of the present disclosure. Therefore, the exemplary embodiments disclosed herein should be considered in an illustrative aspect rather than a restrictive aspect. The scope of the present disclosure should be defined by the claims rather than the above-mentioned description, and all differences within the scope equivalent to the claims should be interpreted to fall within the present disclosure.

What is claimed is:

1. A method for classifying generated speech, comprising:
applying a one-dimensional convolution operation to raw speech data to embed the raw speech data into a feature space and extract a feature vector;
quantizing the feature vector by applying the feature vector to a residual vector quantizer; and
applying the quantized result to a classifier model comprising a natural language processing model to output a classification label.

2. The method for classifying generated speech according to claim 1,
wherein the natural language processing model comprises a BERT (Bidirectional Encoder Representations from Transformers) language model, and
wherein the classifier model is configured to output the classification label indicating one of generated speech and real speech based on an output of the BERT language model.

3. The method for classifying generated speech according to claim 2,
wherein the quantized result is represented as a vector reflecting overall contextual structure through the BERT language model, and the vector is passed through a fully connection layer and a softmax activation function of the classifier model to output the classification label indicating one of generated speech and real speech.

4. The method for classifying generated speech according to claim 1,
wherein the residual vector quantizer is configured to quantize the feature vector, which is a one-dimension array of real values, into positive integer values.

5. The method for classifying generated speech according to claim 1,
wherein the residual vector quantizer is configured to quantize the feature vector differently according to a length of the raw speech data.

6. A non-transitory computer-readable recording medium storing a program code for executing the method of claim 1.

7. An apparatus for classifying generated speech, comprising;
a feature extractor configured to apply a one-dimensional convolution operation to raw speech data to embed the raw speech data into a feature space and to extract a feature vector;
a quantizer disposed downstream of the feature extractor and configured to quantize the feature vector; and
a classifier model configured to receive an output of the quantizer and to output a speech classification result with contextual awareness.

8. The apparatus for classifying generated speech according to claim 7,
wherein the quantizer is a residual vector quantizer, and
wherein the quantizer is configured to quantize the feature vector, which is a one-dimension array of real values, into positive integer values.

9. The apparatus for classifying generated speech according to claim 7,
wherein the residual vector quantizer is configured to quantize the feature vector differently according to a length of the raw speech data.

10. The apparatus for classifying generated speech according to claim 7,
wherein the classifier model comprises a natural language processing model including a BERT (Bidirectional Encoder Representations from Transformers) language model at a front end,
wherein a fully connected layer and a softmax activation layer are disposed at a rear end of the BERT language model, and
wherein the output of the quantizer is represented as a vector reflecting overall contextual structure through the BERT language model, and is passed through the fully connected layer and the softmax activation layer to output a classification label indicating one of generated speech and real speech.
